(19) United States
(12) Patent Application Publication
(10) Pub. No.: US 2025/0171664 A1
(43) Pub. Date: May 29, 2025

(54) DOUBLE-SIDED ADHESIVE AND MULTILAYER STRUCTURE

(71) Applicant: INDUSTRIAL TECHNOLOGY RESEARCH INSTITUTE, Hsinchu (TW)

(72) Inventors: Ming-Hsueh CHIANG, Kaohsiung City (TW); Jauder JENG, Hsinchu County (TW); Pei-Ching LIU, Miaoli (TW); Chien-Hsien CHENG, Tainan City (TW)

(73) Assignee: INDUSTRIAL TECHNOLOGY RESEARCH INSTITUTE, Hsinchu (TW)

(21) Appl. No.: 18/905,565

(22) Filed: Oct. 3, 2024

(30) Foreign Application Priority Data
Nov. 29, 2023 (CN) 202311628908.2

(51) Int. Cl. C09J 133/24; C08K 5/315; C09J 7/35

(52) U.S. Cl. CPC C09J 133/24; C08K 5/315; C09J 7/35; C09J 2301/12; C09J 2301/414; C09J 2433/00; C09J 2467/005

(57) ABSTRACT

A double-sided adhesive and a multilayer structure are provided. The double-sided adhesive includes a first adhesive layer and a second adhesive layer. The first adhesive layer is a product of a first adhesive composition, wherein the first adhesive composition includes a first acrylate resin, a first cross-linking agent, and a compound having a structure represented by Formula (I)

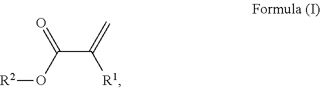

wherein R¹ and R² are as disclosed in the specification. The second adhesive layer is a product of a second adhesive composition. The second adhesive composition includes a second acrylate resin and a second cross-linking agent. The first adhesive layer has a glass transition temperature of Tg¹, and the second adhesive layer has a glass transition temperature of Tg², where Tg² is less than or equal to −30° C., and Tg²-Tg¹≥10° C.

### CROSS REFERENCE TO RELATED APPLICATIONS

This application claims priority of China patent application No. 2023116289082, filed on Nov. 29, 2023, the entirety of which is incorporated by reference herein.

### TECHNICAL FIELD

The disclosure relates to a double-sided adhesive and multilayer structure.

### BACKGROUND

Current touch display technology involves using an optical adhesive to bond and fix a cover plate to the touch panel of the touch display, and the optical adhesive is also used to bond and fix a polarizer plate to the touch panel. Conventional optical adhesive products are used in order to prevent delamination of the two adhered plates. What is often emphasized is the strong adhesion of conventional optical adhesive products, but these strong bonding properties can also lead to inconvenience in later reworking.

There are two main methods of performing a panel reworking process. In one method, the two adhered plates are subjected to a low-temperature treatment before separating the two plates adhered with the optical adhesive layer. In the other method, mechanical cutting is performed on the optical adhesive layer to separate the two adhered plates. Both methods require substantial labor and the use of solvents to remove the bonded adhesive, which is time-consuming and not environmentally friendly. Moreover, the polarizer plate is highly susceptible to be damaged during the residual adhesive removal process.

In addition, when there are steps or gaps on the bonding surface of the touch panel, the optical adhesive used can lead to failure to fill the steps or gaps if it has an insufficient gap-filling capability, thereby compromising the performance of the display.

### SUMMARY

The disclosure provides a double-sided adhesive. According to embodiments of the disclosure, the double-sided adhesive includes a first adhesive layer and a second adhesive layer. The first adhesive layer is a product of a first adhesive composition via a cross-linking reaction, wherein the first adhesive composition includes a first acrylic resin, a first crosslinking agent, and a compound having a structure represented by Formula (I)

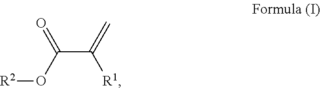

wherein R¹ is hydrogen or methyl group; and R² is

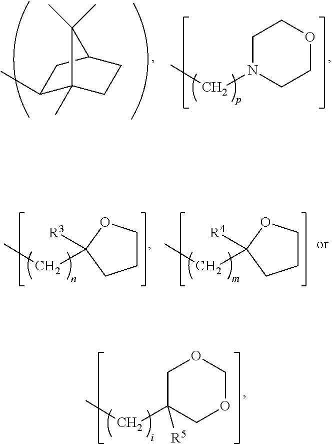

wherein p is 1, 2 or 3; n is 0, 1, 2 or 3; m is 0, 1, 2 or 3; i is 0, 1, 2 or 3; and R³, R⁴ and R⁵ are independently hydrogen or C₁-C₄ alkyl group. The second adhesive layer is a product of a second adhesive composition via a cross-linking reaction, wherein the second adhesive composition includes a second acrylic resin and a second crosslinking agent. The first adhesive layer has a glass transition temperature of Tg¹, and the second adhesive layer has a glass transition temperature of Tg², wherein Tg² is less than or equal to −30° C., and Tg²−Tg¹≥10° C.

According to embodiments of the disclosure, the disclosure also provides a multilayer structure. The multilayer structure may include a first substrate, a second substrate, and the double-sided adhesive of the disclosure. The first adhesive layer of the double-sided adhesive has a first surface, and the second adhesive layer of the double-sided adhesive has a second surface, wherein the first surface contacts the first substrate, and the second surface contacts the second substrate.

### BRIEF DESCRIPTION OF THE DRAWINGS

The present disclosure can be more fully understood by reading the subsequent detailed description and examples with references made to the accompanying drawings, wherein:

FIG. 1 is a sectional view of the double-sided adhesive according to an embodiment of the disclosure.

FIG. 2 is a sectional view of the multilayer structure according to an embodiment of the disclosure.

FIG. 3 is a sectional view of the multilayer structure according to another embodiment of the disclosure.

### DETAILED DESCRIPTION

The double-sided adhesive and multilayer structure of the disclosure are disclosed in detail in the following description. In the following detailed description, for purposes of explanation, numerous specific details and embodiments are set forth in order to provide a thorough understanding of the present disclosure. The specific elements and configurations disclosed in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. As used herein, the term “about” in quantitative terms refers to plus or minus an amount that is general and reasonable to persons skilled in the art.

Furthermore, the use of ordinal terms such as “first”, “second”, “third”, etc., in the disclosure to modify an element does not by itself connote any priority, precedence, order of one claim element over another or the temporal order in which it is formed, but are used merely as labels to distinguish one claim element having a certain name from another element having the same name (but for use of the ordinal term) to distinguish the claim elements.

It should be noted that the elements or devices in the drawings of the disclosure may be present in any form or configuration known to those skilled in the art. In addition, the expression “a layer overlying another layer”, “a layer is disposed above another layer”, “a layer is disposed on another layer”, and “a layer is disposed over another layer” may refer to a layer that directly contacts the other layer, and they may also refer to a layer that does not directly contact the other layer, there being one or more intermediate layers disposed between the layer and the other layer.

The disclosure provides a double-sided adhesive, such as a freeze-peelable double-sided adhesive exhibiting a high gap-filling capability. According to embodiments of the disclosure, the double-sided adhesive of the disclosure has a first adhesive layer and a second adhesive layer. The glass transition temperature of the first adhesive layer and the glass transition temperature of the second adhesive layer are adjusted to match a specific relationship by controlling the difference in monomer amount of the first adhesive layer and the second adhesive layer. Consequently, the double-sided adhesive exhibits a significant difference in adhesion between the first adhesive layer and the second adhesive layer after undergoing low-temperature treatment. It allows the double-sided adhesive to be easily peeled off from the substrate (the substrate in contact with the second adhesive layer of the double-sided adhesive) during the reworking process without leaving residual adhesive. By means of the specific components of the first adhesive layer, the first adhesive layer exhibits superior gap-filling capability. Therefore, even if there are steps or gaps on the bonding surface of the substrate, the first adhesive layer of the double-sided adhesive of the disclosure can fill these steps or gaps and prevent the formation of void defects in the bonding structure.

According to embodiments of the disclosure, the disclosure also provides a multilayer structure including the double-sided adhesive, such as a display panel. According to embodiments of the disclosure, the first adhesive layer of the double-sided adhesive may have a first surface and the second adhesive layer of the double-sided adhesive may have a second surface. The first surface may be used to adhere and fix the touch panel, and the second surface may be used to adhere and fix the polarizer plate of the display module. After undergoing low-temperature treatment, the adhesion of the first surface and the second surface of the double-sided adhesive both decrease, resulting in a significant difference in adhesivity between the first surface of the first adhesive layer and the second surface of the second adhesive layer. After the rework peeling process, the two adhered substrates can be separated easily, with the double-sided adhesive of the disclosure only remaining on one substrate (such as the touch panel) without simultaneously leaving residue on both substrates (such as avoiding residue on the polarizer plate). As a result, the reuse rate of display panel components is improved, and the efficiency of the reworking process is accelerated. In addition, due to the superior gap-filling capability of the first adhesive layer, the adhesive can tightly adhere to substrates with steps (such as touch panels with protrudes) without generating void defects.

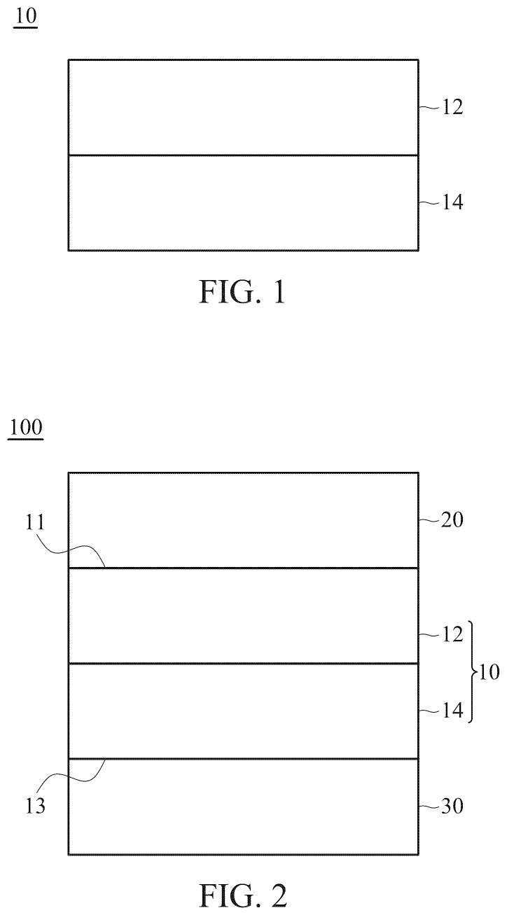

According to embodiments of the disclosure, as shown in FIG. 1, the double-sided adhesive 10 may include a first adhesive layer 12 and a second adhesive layer 14, wherein the first adhesive layer has a first surface, and the second adhesive layer has a second surface. The first adhesive layer 12 may be a product of a first adhesive composition via a cross-linking reaction. The second adhesive layer 14 may be a product of a second adhesive composition via a cross-linking reaction.

The first adhesive composition may include a first acrylic resin, a first crosslinking agent, and a compound having a structure represented by Formula (I)

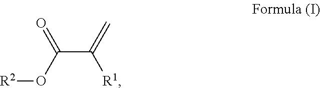

wherein R¹ is hydrogen or methyl group; and R² is

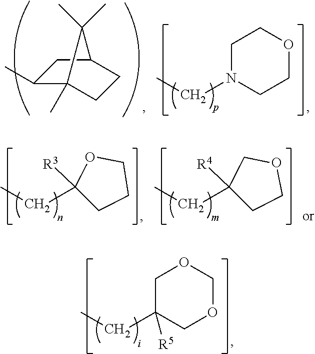

wherein p is 1, 2 or 3; n is 0, 1, 2 or 3; m is 0, 1, 2 or 3; i is 0, 1, 2 or 3; and R³, R⁴ and R⁵ are independently hydrogen or C₁-C₄ alkyl group. According to embodiments of the disclosure, by means of the specific components and weight ratio of the first adhesive composition, the first adhesive layer 12 prepared from the first adhesive composition has superior gap-filling capability.

According to embodiments of the disclosure, the weight ratio of the compound having a structure represented by Formula (I) and the first acrylic resin may be 10:90 to 25:75, such as 11:89, 12:88, 13:87, 14:86, 15:85, 16:84, 17:83, 18:82, 19:81, 20:80, 21:79, 22:78, 23:77 or 24:76. When the weight ratio of the compound having a structure represented by Formula (I) to the first acrylic resin is too high or too low, the first adhesive layer 12 exhibits inferior gap-filling capability. In addition, the second adhesive composition may include a second acrylic resin and a second crosslinking agent.

According to embodiments of the disclosure, C₁-C₄ alkyl group may be linear or branched. For example, C₁-C₄ alkyl group may be methyl group, ethyl group, propyl group, butyl group or an isomer thereof.

According to embodiments of the disclosure, the compound having a structure represented by Formula (I) may be

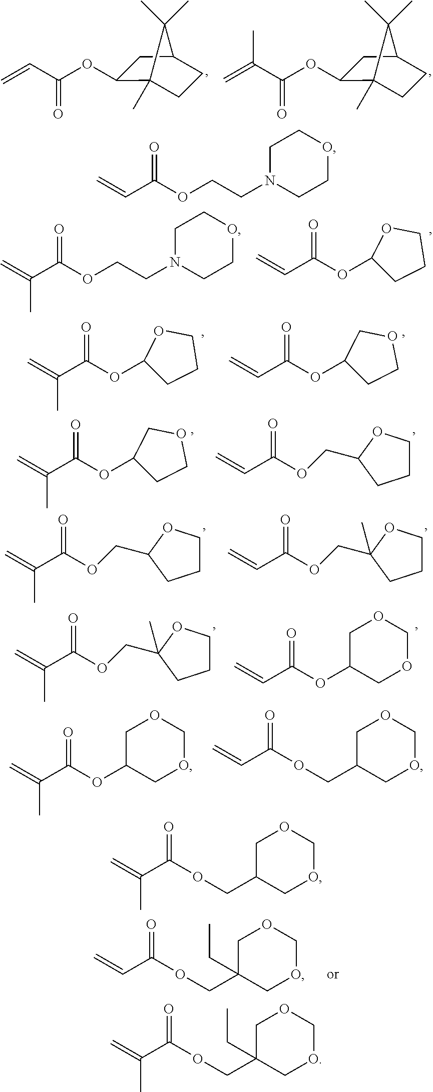

According to embodiments of the disclosure, the first acrylic resin may be a product of a first resin composition via copolymerization, wherein the first resin composition may include an (A1) monomer (i.e., component (A1)), wherein the (A1) monomer may include a first monomer, a second monomer, and a third monomer. According to embodiments of the disclosure, the total amount of the first monomer, second monomer, and third monomer may be 95 wt % to 100 wt %, based on the total weight of the (A1) monomer.

According to embodiments of the disclosure, the (A1) monomer may consist of a main monomer and a minor monomer, wherein the main monomer may consist of the first monomer, second monomer, and third monomer, and the minor monomer may consist of a monomer which could be reacted with a (meth)acrylate. Herein, the main monomer may have a weight percentage of 95 wt % to 99.9 wt %, and the miner monomer may have a weight percentage of 0.1 wt % to 5 wt %. According to embodiments of the disclosure, the (A1) monomer may consist of the first monomer, second monomer, and third monomer.

According to embodiments of the disclosure, the second acrylic resin may be a product of a second resin composition via copolymerization, wherein the second resin composition may include a (B1) monomer (i.e., component (B1)), wherein the (B1) monomer may include the first monomer, second monomer, and third monomer. According to embodiments of the disclosure, the total amount of the first monomer, second monomer, and third monomer may be 95 wt % to 100 wt %, based on the total weight of the (B1) monomer.

According to embodiments of the disclosure, the (B1) monomer may consist of a main monomer and a minor monomer, wherein the main monomer may consist of the first monomer, second monomer, and third monomer, and the minor monomer may consist of a monomer which could be reacted with a (meth)acrylate. Herein, the main monomer may have a weight percentage of 95 wt % to 99.9 wt %, and the miner monomer may have a weight percentage of 0.1 wt % to 5 wt %. According to embodiments of the disclosure, the (B1) monomer may consist of the first monomer, second monomer, and third monomer.

According to embodiments of the disclosure, the third monomer has a weight percentage of W1 in the (A1) monomer, based on the total weight of the (A1) monomer (or based on the total weight of the first monomer, second monomer, and third monomer of the first resin composition). The third monomer has a weight percentage of W2 in the (B1) monomer, based on the total weight of the (B1) monomer (or based on the total weight of the first monomer, second monomer, and third monomer of the second resin composition).

It should be noted that, the weight percentage W1 and the weight percentage W2 conform to the following equation: 45 wt %≥W2-W1≥7 wt % (such as: 40 wt %≥W2-W1≥7 wt % 35 wt %≥W2-W1≥7 wt %, 32 wt %≥W2-W1≥7 wt % or 28 wt %≥W2-W1≥7 wt %). According to embodiments of the disclosure, when the difference between the weight percentage W2 and the weight percentage W1 (W2-W1) is less than 7, there will not be a significant difference in adhesivity between the first adhesive layer and the second adhesive layer in the double-sided adhesive after low-temperature treatment.

According to embodiments of the disclosure, the first resin composition, apart from the first monomer, second monomer, and third monomer, does not include any other reactive monomers (i.e., monomers that can form repeating units of the first acrylic resin). According to embodiments of the disclosure, the second resin composition, apart from the first monomer, second monomer, and third monomer, does not include any other reactive monomers (i.e., monomers that can form repeating units of the second acrylic resin).

According to embodiments of the disclosure, the components of the (A1) monomer in the first resin composition are the same as the components of the (B1) monomer in the second resin composition (but with different amounts of the components). Namely, the first monomer of the first resin composition may be the same as the first monomer of the second resin composition, the second monomer of the first resin composition may be the same as the second monomer of the second resin composition, and the third monomer of the first resin composition may be the same as the third monomer of the second resin composition.

According to embodiments of the disclosure, the components of the (A1) monomer of the first resin composition are different from the components of the (B1) monomer of the second resin composition. Namely, the first monomer of the first resin composition is different from the first monomer of the second resin composition, the second monomer of the first resin composition is different from the second monomer of the second resin composition, and/or the third monomer of the first resin composition is different from the third monomer of the second resin composition.

According to embodiments of the disclosure, the first monomer may be a (meth)acrylate monomer having a hydroxyl group. According to some embodiments of the disclosure, the first monomer may be

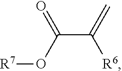

wherein R⁶ may be hydrogen or methyl group, and R⁷ may be hydrogen or C1-C10 alkylol group. According to embodiments of the disclosure, C1-C10 alkylol group may be linear or branched. For example, C1-C10 alkylol group may be methylol group, ethylol group, propylol group, butylol group, pentylol group, hexylol group or an isomer thereof. For example, the first monomer may be acrylic acid, methacrylic acid, hydroxyethyl acrylate, hydroxyethyl methacrylate, hydroxypropyl acrylate, hydroxypropyl methacrylate, hydroxybutyl acrylate, hydroxybutyl methacrylate, or a combination thereof.

According to embodiments of the disclosure, the second monomer may be a soft monomer, where the soft monomer refers to a (meth)acrylate monomer whose homopolymer has a glass transition temperature (Tg) less than or equal to −20° C. (such as −20° C. to −100° C., −20° C. to −90° C., −20° C. to −80° C., or −20° C. to −70° C.). Specifically, the second monomer may be a (meth)acrylate monomer whose homopolymer has a glass transition temperature (Tg) of less than or equal to −20° C. The glass transition temperature is measured via differential scanning calorimetry (DSC) at a heating rate of 10° C./min or referenced from the POLYMER HANDBOOK (Wiley-Interscience) and similar sources. For example, the second monomer may include n-butyl acrylate, sec-butyl acrylate, ethyl acrylate, 2-ethylhexyl acrylate, ethoxyethyl acrylate, isononyl acrylate, lauryl methacrylate, or a combination thereof.

According to embodiments of the disclosure, the third monomer may be a hard monomer, wherein the hard monomer refers to a monomer having a terminal vinyl group whose homopolymer has a glass transition temperature (Tg) greater than or equal to 0° C. (such as 0° C. to 200° C., 0° C. to 180° C., 0° C. to 150° C. or 0° C. to 130° C.).

Namely, the third monomer may be a monomer having a terminal vinyl group whose homopolymer has a glass transition temperature (Tg) greater than or equal to 0° C. For example, the third monomer may be tert-butyl acrylate, n-butyl methacrylate, sec-butyl methacrylate, tert-butyl methacrylate, cyclohexyl acrylate, cyclohexyl methacrylate, isobornyl acrylate, isobornyl methacrylate, methyl acrylate, methyl methacrylate, acrylonitrile, acrylamide, acryloyl morpholine, N-vinyl-2-pyrrolidone or a combination thereof.

According to embodiments of the disclosure, in the (A1) monomer, the first monomer has a weight percentage of 1 wt % to 10 wt % (such as 2 wt %, 3 wt %, 4 wt %, 5 wt %, 6 wt %, 7 wt %, 8 wt % or 9 wt %), based on the total weight of the (A1) monomer. When the weight percentage of the first monomer is 1 wt % to 10 wt % in the (A1) monomer, the first resin composition has an appropriate amount of hydroxyl groups and can further react with a crosslinking agent, resulting in a crosslinked product with weather resistance.

According to embodiments of the disclosure, in the (B1) monomer, the first monomer has a weight percentage of 1 wt % to 10 wt % (such as 2 wt %, 3 wt %, 4 wt %, 5 wt %, 6 wt %, 7 wt %, 8 wt % or 9 wt %), based on the total weight of the (B1) monomer. When the weight percentage of the first monomer in the (B1) monomer is 1 wt % to 10 wt %, the second resin composition has an appropriate amount of hydroxyl groups and can further react with a crosslinking agent, resulting in a crosslinked product with weather resistance.

According to embodiments of the disclosure, in the (A1) monomer, the first monomer has a weight percentage of 1 wt % to 10 wt %, based on the total weight of the first monomer, second monomer, and third monomer. According to embodiments of the disclosure, in the (B1) monomer, the first monomer has a weight percentage of 1 wt % to 10 wt %, based on the total weight of the first monomer, second monomer, and third monomer.

According to embodiments of the disclosure, in the (A1) monomer, the second monomer has a weight percentage of 50 wt % to 95 wt % (such as 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt % or 94 wt %), based on the total weight of the (A1) monomer. According to embodiments of the disclosure, in the (B1) monomer, the second monomer has a weight percentage of 50 wt % to 95 wt % (such as 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt % or 94 wt %), based on the total weight of the (B1) monomer.

According to embodiments of the disclosure, in the (A1) monomer, the second monomer has a weight percentage of 50 wt % to 95 wt %, based on the total weight of the first monomer, second monomer, and third monomer. According to embodiments of the disclosure, in the (B1) monomer, the second monomer has a weight percentage of 50 wt % to 95 wt %, based on the total weight of the first monomer, second monomer, and third monomer.

According to embodiments of the disclosure, in the (A1) monomer, the third monomer has a weight percentage of 4 wt % to 42 wt % (such as 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt % or 41 wt %), based on the total weight of the (A1) monomer. According to embodiments of the disclosure, in the (B1) monomer, the third monomer has a weight percentage of 11 wt % to 49 wt % (such as 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt % or 48 wt %), based on the total weight of the (B1) monomer.

According to embodiments of the disclosure, when the amount of the soft monomer (i.e. (meth)acrylate monomer whose homopolymer has a glass transition temperature of less than or equal to −20° C.) in the first resin composition or the second resin composition is high, the obtained acrylic resin has a lower glass transition temperature. In addition, in the first resin composition or the second resin composition, when the amount of the hard monomer (i.e., (meth)acrylate monomer whose homopolymer has a glass transition temperature greater than or equal to 0° C.) is high, the obtained acrylic resin has a higher glass transition temperature.

According to embodiments of the disclosure, the first acrylic resin in the first adhesive layer has a glass transition temperature of Tg¹, and the second acrylic resin in the second adhesive layer has a glass transition temperature of Tg², wherein Tg² is less than or equal to −30° C. (such as less than or equal to −31° C. or less than or equal to −32° C.), and Tg²-Tg¹≥10° C. (such as Tg²-Tg¹≥11° C., Tg²-Tg¹≥12° C. or Tg²-Tg¹≥13° C.). Therefore, by adjusting the amount of the hard monomer (i.e., the third monomer) in the first resin composition and second resin composition, the glass transition temperature (Tg) difference between the first adhesive layer and second adhesive layer (i.e., Tg²-Tg¹≥10° C.) can be obtained. Consequently, when subjecting the double-sided adhesive of the disclosure to a low-temperature treatment, the difference in adhesivity between the first adhesive layer and the second adhesive layer can further increase, thereby allowing the double-sided adhesive to be predominantly peeled from the second adhesive layer side without leaving adhesive residue.

According to embodiments of the disclosure, the Fox equation can be applied to estimate the glass transition temperature (Tg) of acrylic resin used in the adhesive layer (such as the first adhesive layer or the second adhesive layer). The Fox equation is expressed as follows:

$$1 / Tg = W 1 / Tg 1 + W 2 / Tg 2 + W 3 / Tg 3 + … Wn / Tgn ,$$

wherein Tg is the estimated glass transition temperature (K) of the acrylic resin; W1 is the weight fraction of the monomer (1); Tg1 is the glass transition temperature (K) of the homopolymer prepared from the monomer (1); W2 is the weight fraction of the monomer (2); Tg2 is the glass transition temperature (K) of the homopolymer prepared from the monomer (2); W3 is the weight fraction of the monomer (3); Tg3 is the glass transition temperature (K) of the homopolymer prepared from the monomer (3); Wn is the weight fraction of the monomer (n); Tgn is the glass transition temperature (K) of the homopolymer prepared from the monomer (n); and the monomers from monomer (1) to monomer (n) refer to the various monomers used to prepare the acrylic resin (such as in the first resin composition or second resin composition), and the obtained acrylic resin is used to prepare the adhesive layer.

According to embodiments of the disclosure, when the double-sided adhesive is subjected to a low-temperature treatment in the reworking process, the temperature (T) of the low-temperature treatment may be lower than the glass transition temperature (Tg¹) of the first acrylic resin used in the first adhesive layer and the glass transition temperature (Tg²) of the second acrylic resin used in the second adhesive layer. Namely, the relationship among the low-temperature treatment temperature (T), the glass transition temperature (Tg¹) of the first acrylic resin in the first adhesive layer, and the glass transition temperature (Tg²) of the second acrylic resin in the second adhesive layer may be as follows: Tg²>Tg¹>T. Consequently, after the double-sided adhesive of the disclosure undergoes the low-temperature treatment, significant differences in adhesivity can be observed between the first adhesive layer and the second adhesive layer.

According to embodiments of the disclosure, the difference between the glass transition temperature (Tg²) of the second acrylic resin in the second adhesive layer and the glass transition temperature (Tg¹) of the first acrylic resin in the first adhesive layer (i.e., Tg²-Tg¹) can be larger than or equal to 10° C. (i.e., Tg²-Tg¹≥10° C.).

According to embodiments of the disclosure, when subjecting the double-sided adhesive to low-temperature treatment during the reworking process, the temperature (T) of the low-temperature treatment can be between the glass transition temperature (Tg¹) of the first acrylic resin used in the first adhesive layer and the glass transition temperature (Tg²) of the second acrylic resin used in the second adhesive layer. Namely, the relationship among the low-temperature treatment temperature (T), the glass transition temperature (Tg¹) of the first acrylic resin in the first adhesive layer, and the glass transition temperature (Tg²) of the second acrylic resin in the second adhesive layer can be as follows: Tg²>T>Tg¹. As a result, after the double-sided adhesive of the disclosure undergoes low-temperature treatment, the difference in adhesivity between the first adhesive layer and the second adhesive layer can be further increased. This ensures that the double-sided adhesive can be easily removed from the substrate (the substrate in contact with the second adhesive layer of the double-sided adhesive) during the reworking process, without leaving residue. According to embodiments of the disclosure, when the low-temperature treatment temperature (T) is between the glass transition temperature (Tg¹) of the first acrylic resin used in the first adhesive layer and the glass transition temperature (Tg²) of the second acrylic resin used in the second adhesive layer, the energy consumed for the low-temperature treatment can be reduced (i.e., there is no need to lower the temperature below the glass transition temperature (Tg¹) of the acrylic resin used in the first adhesive layer).

According to embodiments of the disclosure, the process time of the low-temperature treatment of the disclosure may be about 1 minute to 1 hour, such as 2 minutes, 3 minutes, 4 minutes, 5 minutes, 10 minutes, 15 minutes, 20 minutes, 25 minutes, 30 minutes, 35 minutes, 40 minutes, 45 minutes, 50 minutes or 55 minutes. According to embodiments of the disclosure, the process temperature of the low-temperature treatment of the disclosure may be about −10° C. to −130° C., such as −15° C., −20° C., −25° C., −30° C., −40° C., −50° C., −60° C., −70° C., −80° C., −90° C., −100° C., −110° C. or −120° C. According to embodiments of the disclosure, as the temperature (T) of the low-temperature treatment decreases, the duration of the low-temperature treatment can be reduced.

According to embodiments of the disclosure, the first resin composition may further include an (A2) initiator, wherein the weight ratio of the (A1) monomer to the (A2) initiator may be 10,000:1 to 100:3, such as 8,000:1, 6,000:1, 5,000:1, 3,000:1, 2,000:1, 1,750:1, 1,500:1, 1,250:1, 1,000:1, 750:1, 500:1, 200:1, 100:1, 100:2 or 100:2.5.

According to embodiments of the disclosure, the second resin composition may further include a (B2) initiator, wherein the weight ratio of the (B1) monomer to the (B2) initiator may be 10,000:1 to 100:3, such as 8,000:1, 6,000:1, 5,000:1, 3,000:1, 2,000:1, 1,750:1, 1,500:1, 1,250:1, 1,000:1, 750:1, 500:1, 200:1, 100:1, 100:2 or 100:2.5.

According to embodiments of the disclosure, the (A2) initiator and the (B2) initiator may be thermal initiator. According to embodiments of the disclosure, the (A2) initiator and the (B2) initiator are not limited and can be optionally selected by a person skilled in the field, maybe azo compound, cyanovaleric-acid-based compound, peroxide, benzoin-based compound, acetophenone-based compound, thioxanthone-based compound, ketal compound, benzophenone-based compound, α-aminoacetophenone compound, acylphosphineoxide compound, biimidazole-based compound, triazine-based compound, or a combination thereof.

According to embodiments of the disclosure, the azo compound may be 2,2′-azobis(2,4-dimethyl valeronitrile), dimethyl 2,2′-azobis(2-methylpropionate), 2,2-azobisisobutyronitrile (AIBN), 2,2-azobis(2-methylisobutyronitrile), 1,1′-azobis(cyclohexane-1-carbonitrile), 2,2′-azobis[N-(2-propenyl)-2-methylpropionamide], 1-[(cyano-1-methylethyl)azo]formamide, 2,2′-azobis(N-butyl-2-methylpropionamide), or 2,2′-azobis(N-cyclohexyl-2-methylpropionamide). Peroxides may be benzoyl peroxide, 1,1-bis(tert-butylperoxy)cyclohexane, 2,5-bis(tert-butylperoxy)-2,5-dimethylcyclohexane, 2,5-bis(tert-butylperoxy)-2,5-dimethyl-3-cyclohexyne, bis(1-(tert-butylpeorxy)-1-methy-ethyl)benzene, tert-butyl hydroperoxide, tert-butyl peroxide, tert-butyl peroxybenzoate, cumene hydroperoxide, cyclohexanone peroxide, dicumyl peroxide, or lauroyl peroxide; the benzoin-based compound may be benzoin, benzoin methyl ether or benzoin dimethyl ether; the acetophenone-based compound may be p-dimethylamino-acetophenone, α, α′-dimethoxyazoxy-acetophenone, 2,2′-dimethyl-2-phenyl-acetophenone, p-methoxy-acetophenone, 2-methyl-1-(4-methylthiophenyl)-2-morpholino-1-propanone, or 2-benzyl-2-N,N-dimethylamino-1-(4-morpholinophenyl)-1-butanone; the benzophenone-based compound may be benzophenone, 4,4-bis(dimethylamino)benzophenone, 4,4-bis(diethylamino)benzophenone, 2,4,6-trimethylaminobenzophenone, methyl-o-benzoyl benzoate, 3,3-dimethyl-4-methoxybenzophenone, or 3,3,4,4-tetra(t-butylperoxycarbonyl)benzophenone; the thioxanthone-based compound may be thioxanthone, 2,4-diethyl-thioxanthanone, or thioxanthone-4-sulfone; the biimidazole-based compound may be 2,2′-bis(o-chlorophenyl)-4,4′,5,5′-tetraphenyl-biimidazole, 2,2′-bis(o-fluorophenyl)-4,4′,5,5′-tetraphenyl-biimidazole, 2,2′-bis(o-methylphenyl)-4,4′,5,5′-tetraphenyl-biimidazole, 2,2′-bis(o-methoxyphenyl)-4,4′,5,5′-tetraphenyl-biimidazole, 2,2′-bis(o-ethylphenyl)-4,4′,5,5′-tetraphenyl-biimidazole, 2,2′-bis(p-methoxyphenyl)-4,4′, 5,5′-tetraphenyl-biimidazole, 2,2′-bis(2,2′,4,4′-tetramethoxyphenyl)-4,4′,5,5′-tetraphenyl-biimidazole, 2,2′-bis(2-chlorophenyl)-4,4′,5,5′-tetraphenyl-biimidazole], or 2,2′-bis(2,4-dichlorophenyl)-4,4′,5,5′-tetraphenyl-biimidazole; the phosphineoxide compound may be 2,4,6-trimethylbenzoyl diphenylphosphine oxide or bis(2,6-dimethoxybenzoyl)-2,4,4-trimethylpentylphosphine oxide); the triazine-based compound may be 3-{4-[2,4-bis(trichloromethyl)-s-triazine-6-yl]phenylthio}propionic acid, 1,1,1,3,3,3-hexafluoroisopropyl-3-{4-[2,4-bis(trichloromethyl)-s-triazine-6-yl]phenylthio}propionate, ethyl-2-{4-[2,4-bis(trichloromethyl)-s-triazine-6-yl]phenylthio}acetate, 2-epoxyethyl-2-{4-[2,4-bis(trichloromethyl)-s-triazine-6-yl]phenylthio}acetate, cyclohexyl-2-{4-[2,4-bis(trichloromethyl)-s-triazine-6-yl]phenylthio}acetate, benzyl-2-{4-[2,4-bis(trichloromethyl)-s-triazine-6-yl]phenylthio}acetate, 3-{chloro-4-[2,4-bis(trichloromethyl)-s-triazine-6-yl]phenylthio}propionic acid, 3-{4-[2,4-bis(trichloromethyl)-s-triazine-6-yl]phenylthio}propionamide, 2,4-bis(trichloromethyl)-6-p-methoxystyryl-s-triazine, 2,4-bis(trichloromethyl)-6-(1-p-dimethylaminophenyl)-1,3,-butadienyl-s-triazine or 2-trichloromethyl-4-amino-6-p-methoxystyryl-s-triazine.

According to embodiments of the disclosure, the first resin composition may further include an (A3) solvent. The amount of the solvent is not particularly limited and can be optionally adjusted by a person skilled in the field depending on the application as long as the (A1) monomer and (A2) initiator can be uniformly dispersed in the solvent. For example, the solid content of the first resin composition may be 20% to 70% (such as about 25%, 30%, 35%, 40%, 45%, 50%, 55%, 60% or 65%). Herein, the solid content means a weight percentage of the components of the first resin composition except the solvent, based on the total weight of the first resin composition.

According to embodiments of the disclosure, the second resin composition may further include a (B3) solvent. The amount of the solvent is not limited and can be optionally adjusted by a person skilled in the field depending on the application as long as the (B1) monomer and (B2) initiator can be uniformly dispersed in the solvent. For example, the solid content of the second resin composition may be 20% to 70% (such as about 25%, 30%, 35%, 40%, 45%, 50%, 55%, 60% or 65%). Herein, the solid content means a weight percentage of the components of the second resin composition except the solvent, based on the total weight of the second resin composition.

According to embodiments of the disclosure, the (A3) solvent and (B3) solvent may be independently aromatic hydrocarbon solvent, alcohol solvent, ether solvent, ketone solvent, ester solvent, nitrogen-containing solvent, or a combination thereof. According to embodiments of the disclosure, the (A3) solvent and (B3) solvent may be independently benzene, toluene, xylene, ethylbenzene, diethylbenzene, trimethylbenzene, triethylbenzene, cyclohexane, cyclohexene, decahydronaphthalene, dipentene, pentane, hexane, heptane, octane, nonane, decane, ethyl cyclohexane, methyl cyclohexane, p-menthane, dipropyl ether, dibutyl ether, anisole, ethyl acetate, butyl acetate, pentyl acetate, methyl isobutyl ketone, cyclohexylbenzene, cyclohexanone, cyclopentanone (CPN), triglyme, 1,3-dimethyl-2-imidazolidinone (DMI), N-methyl-2-pyrrolidone (NMP), methyl ethyl ketone (MEK), N,N-dimethylacetamide (DMAc), γ-butyrolactone (GBL), N,N-dimethylformamide (DMF), propylene glycol methyl ether acetate (PGMEA), dimethyl sulfoxide (DMSO), or a combination thereof.

According to embodiments of the disclosure, the first resin composition may consist of the (A1) monomer, (A2) initiator, and (A3) solvent. According to embodiments of the disclosure, the second resin composition may consist of the (B1) monomer, (B2) initiator, and (B3) solvent.

According to embodiments of the disclosure, the molecular weight of the first acrylic resin of the disclosure is not limited and can be optionally modified by a person skilled in the field, in order to react the first acrylic resin with the first crosslinking agent to undergo a cross-linking reaction, forming the first adhesive layer. According to embodiments of the disclosure, the weight average molecular weight (Mw) of the first acrylic resin may be about 50,000 (g/mol) to 500,000 (g/mol), such as about 80,000 (g/mol), 100,000 (g/mol), 200,000 (g/mol), 300,000 (g/mol) or 400,000 (g/mol).

According to embodiments of the disclosure, the molecular weight of the second acrylic resin of the disclosure is not limited and can be optionally modified by a person skilled in the field, in order to react the second acrylic resin with the second crosslinking agent to undergo a cross-linking reaction, forming the second adhesive layer. According to embodiments of the disclosure, the weight average molecular weight (Mw) of the second acrylic resin may be about 50,000 (g/mol) to 500,000 (g/mol), such as about 80,000 (g/mol), 100,000 (g/mol), 200,000 (g/mol), 300,000 (g/mol) or 400,000 (g/mol). The weight average molecular weight (Mw) of the acrylic resin of the disclosure can be determined by gel permeation chromatography (GPC) based on a polystyrene calibration curve.

According to embodiments of the disclosure, the method for preparing the acrylic resin of the disclosure may include the following steps. First, a resin composition (such as the first resin composition or second resin composition) is provided. Next, the resin composition is subjected to a heating process, wherein the temperature of the heating process may be 60° C. to 130° C., and the process time may be 5 hours to 24 hours.

According to embodiments of the disclosure, in the first adhesive composition, the weight ratio of the first crosslinking agent to the first acrylic resin may be about 1:5,000 to 5:100, such as 2:5,000, 3:5,000, 4:5,000, 1:1,000, 2:1,000, 3:1,000, 4:1,000, 5:1,000, 8:1,000, 1:100, 2:100, 3:100 or 4:100. According to embodiments of the disclosure, in the second adhesive composition, the weight ratio of the second crosslinking agent and the second acrylic resin maybe about 1:5,000 to 5:100, such as 3:1,000, 4:1,000, 5:1,000, 8:1,000, 1:100, 2:100, 3:100 or 4:100.

According to embodiments of the disclosure, the first crosslinking agent and second crosslinking agent may be independently a compound with at least two cross-linkable functional groups (such as compound with two cross-linkable functional groups, compound with three cross-linkable functional groups, compound with four cross-linkable functional groups or compound with five cross-linkable functional groups), wherein the cross-linkable functional group may be isocyanate group, carboxyl group, aziridine group, anhydride group or melamine group. For example, the first crosslinking agent and second crosslinking agent may be independently 2,4-toluene diisocyanate, 2,5-toluene diisocyanate, 2,6-toluene diisocyanate, hexamethylene diisocyanate (HMDI), pentamethylene diisocyanate, isophorone diisocyanate, 4,4′-methylene dicyclohexyl diisocyanate, 4,4′-methylenediphenyl diisocyanate, or a combination thereof.

According to embodiments of the disclosure, the first adhesive composition may further include a photo-initiator to increase the adhesivity. According to embodiments of the disclosure, in the first adhesive composition, the weight ratio of the photo-initiator to the first acrylic resin may be 0.01:99.99 to 3:97, such as 0.05:99.95, 0.1:99.9, 0.2:99.8, 0.3:99.7, 0.5:99.5, 1:99, 1.5:98.5, 2:98 or 2.5:97.5. When the weight ratio of the photo-initiator to the first acrylic resin is too high, the first adhesive layer is apt to degradation and yellowing issues.

According to embodiments of the disclosure, the first adhesive composition may further include a first solvent. The amount of the first solvent is not limited and can be optionally adjusted by a person skilled in the field as long as the first acrylic resin, a compound having a structure represented by Formula (I), and first crosslinking agent can be uniformly dispersed in the solvent. For example, the solid content of the first adhesive composition may be 20% to 70% (such as about 25%, 30%, 35%, 40%, 45%, 50%, 55%, 60% or 65%). Herein, the solid content means a weight percentage of the components of the first adhesive composition except the first solvent, based on the total weight of the first adhesive composition.

According to embodiments of the disclosure, the second adhesive composition may further include a photo-initiator to increase the adhesivity. According to embodiments of the disclosure, in the second adhesive composition, the weight ratio of the photo-initiator to the second acrylic resin may be 0.01:99.99 to 3:97, such as 0.05:99.95, 0.1:99.9, 0.2:99.8, 0.3:99.7, 0.5:99.5, 1:99, 1.5:98.5, 2:98 or 2.5:97.5. When the weight ratio of the photo-initiator to the second acrylic resin is too high, the second adhesive layer is apt to degradation and yellowing issues. According to embodiments of the disclosure, the second adhesive composition may further include a second solvent. The amount of the second solvent is not limited and can be optionally adjusted by a person skilled in the field as long as the second acrylic resin and second crosslinking agent can be uniformly dispersed in the solvent. For example, the solid content of the second adhesive composition may be 20% to 70% (such as about 25%, 30%, 35%, 40%, 45%, 50%, 55%, 60% or 65%). Herein, the solid content means a weight percentage of the components of the second adhesive composition except the second solvent, based on the total weight of the first adhesive composition.

According to embodiments of the disclosure, the first solvent and second solvent may be independently aromatic hydrocarbon solvent, alcohol solvent, ether solvent, ketone solvent, ester solvent, nitrogen-containing solvent, or a combination thereof.

According to embodiments of the disclosure, the first solvent and second solvent may be independently benzene, toluene, xylene, ethylbenzene, diethylbenzene, trimethylbenzene, triethylbenzene, cyclohexane, cyclohexene, decahydronaphthalene, dipentene, pentane, hexane, heptane, octane, nonane, decane, ethyl cyclohexane, methyl cyclohexane, p-menthane, dipropyl ether, dibutyl ether, anisole, ethyl acetate, butyl acetate, pentyl acetate, methyl isobutyl ketone, cyclohexylbenzene, cyclohexanone, cyclopentanone (CPN), triglyme, 1,3-dimethyl-2-imidazolidinone (DMI), N-methyl-2-pyrrolidone (NMP), methyl ethyl ketone (MEK), N,N-dimethylacetamide (DMAc), γ-butyrolactone (GBL), N,N-dimethylformamide (DMF), propylene glycol methyl ether acetate (PGMEA), dimethyl sulfoxide (DMSO), or a combination thereof.

According to embodiments of the disclosure, the first adhesive composition may consist of the first acrylic resin, a compound having a structure represented by Formula (I), first crosslinking agent, and first solvent. According to embodiments of the disclosure, the first adhesive composition may consist of the first acrylic resin, a compound having a structure represented by Formula (I), first crosslinking agent, photo-initiator, and first solvent. According to embodiments of the disclosure, the second adhesive composition may consist of the second resin composition, second crosslinking agent, and second solvent.

According to embodiments of the disclosure, the first adhesive composition may further include a first catalyst to accelerate the cross-linking reaction of the first adhesive composition. According to embodiments of the disclosure, the weight ratio of the first catalyst to the first acrylic resin may be about 1:10,000 to 1:100, such as 1:5,000, 2:5,000, 3:5,000, 4:5,000, 1:1,000, 2:1,000, 3:1,000, 4:1,000, 5:1,000, 6:1,000, 7:1,000, 8:1,000 or 9:1,000.

According to embodiments of the disclosure, the second adhesive composition may further include a second catalyst to accelerate the cross-linking reaction of the second adhesive composition. According to embodiments of the disclosure, the weight ratio of the second catalyst to the second acrylic resin may be about 1:10,000 to 1:100, such as 1:5,000, 2:5,000, 3:5,000, 4:5,000, 1:1,000, 2:1,000, 3:1,000, 4:1,000, 5:1,000, 6:1,000, 7:1,000, 8:1,000 or 9:1,000.

According to embodiments of the disclosure, the first catalyst and second catalyst may be independently bismuth nitrate, bismuth neodecanoate, lead 2-ethylhexoate, lead benzoate, lithium neodecanoate, ferric chloride, antimony trichloride, antimony glycolate, stannous salts of carboxylic acids, zinc salts of carboxylic acids, dialkyl tin salts of carboxylic acids, glycine salts, tertiary amine trimerization catalysts, quaternary ammonium carboxylates, alkali metal carboxylic acid salts, potassium acetate, potassium octoate, potassium 2-ethylhexanoate, N-(2-hydroxy-5-nonylphenol)methyl-N-methylglycinate, tin (II) 2-ethylhexanoate, dibutyltin dilaurate, or a combination thereof.

According to embodiments of the disclosure, the first adhesive composition may consist of the first resin composition, first crosslinking agent, first solvent, and the first catalyst. According to embodiments of the disclosure, the second adhesive composition may consist of the second resin composition, second crosslinking agent, second solvent, and the second catalyst.

According to embodiments of the disclosure, the first adhesive composition may consist of the first acrylic resin, a compound having a structure represented by Formula (I), first crosslinking agent, first solvent, and the first catalyst. According to embodiments of the disclosure, the first adhesive composition may consist of the first acrylic resin, a compound having a structure represented by Formula (I), first crosslinking agent, photo-initiator, first solvent, and the first catalyst. According to embodiments of the disclosure, the second adhesive composition may consist of the second resin composition, second crosslinking agent, second solvent, and the second catalyst.

The first adhesive composition of the disclosure may substantially consist of the first acrylic resin, a compound having a structure represented by Formula (I), first crosslinking agent, photo-initiator, first solvent, and the first catalyst. Namely, the first acrylic resin, a compound having a structure represented by Formula (I), first crosslinking agent, photo-initiator, first solvent, and the first catalyst serve as the main component of the first adhesive composition. In addition to the main component, the first adhesive composition may optionally include an additive (as a minor component), wherein the additive may be known additives for adhesive layers, such as adhesion promoters, leveling agents, surface treatment agents, viscosity modifiers, stabilizers, and antioxidants. According to embodiments of the disclosure, in the first adhesive composition, the weight ratio of the minor component to the first acrylic resin may be about 1:10,000 to 1:10, such as about 1:5,000, 1:2,500, 1:2,000, 1:1,000, 1:500, 1:300, 1:200, 1:100, 1:50, 1:40, 1:30, 1:20, or 1:15.

According to embodiments of the disclosure, the photo-initiator may be benzoin-based compound, acetophenone-based compound, thioxanthone-based compound, ketal compound, benzophenone-based compound, α-aminoacetophenone compound, acylphosphineoxide compound, biimidazole-based compound, triazine-based compound, or a combination thereof. The benzoin-based compound may be benzoin, benzoin methyl ether or benzoin dimethyl ether; the acetophenone-based compound may be p-dimethylamino-acetophenone,α,α′-dimethoxyazoxy-acetophenone, 2,2′-dimethyl-2-phenyl-acetophenone, p-methoxy-acetophenone, 2-methyl-1-(4-methylthiophenyl)-2-morpholino-1-propanone, 2-benzyl-2-N,N-dimethylamino-1-(4-morpholinophenyl)-1-butanone; the benzophenone-based compound may be benzophenone, 4,4-bis(dimethylamino)benzophenone, 4,4-bis(diethylamino)benzophenone, 2,4,6-trimethylaminobenzophenone, methyl-o-benzoyl benzoate, 3,3-dimethyl-4-methoxybenzophenone, or 3,3,4,4-tetra(t-butylperoxycarbonyl)benzophenone; the thioxanthone-based compound may be thioxanthone, 2,4-diethyl-thioxanthanone, thioxanthone-4-sulfone; the biimidazole-based compound may be [2,2′-bis(o-chlorophenyl)-4,4′,5,5′-tetraphenyl-biimidazole, 2,2′-bis(o-fluorophenyl)-4,4′,5,5′-tetraphenyl-biimidazole, 2,2′-bis(o-methylphenyl)-4,4′,5,5′-tetraphenyl-biimidazole, 2,2′-bis(o-methoxyphenyl)-4,4′,5,5′-tetraphenyl-biimidazole, 2,2′-bis(o-ethylphenyl)-4,4′,5,5′-tetraphenyl-biimidazole, 2,2′-bis(p-methoxyphenyl)-4,4′,5,5′-tetraphenyl-biimidazole, 2,2′-bis(2,2′,4,4′-tetramethoxyphenyl)-4,4′,5,5′-tetraphenyl-biimidazole, 2,2′-bis(2-chlorophenyl)-4,4′,5,5′-tetraphenyl-biimidazole, 2,2′-bis(2,4-dichlorophenyl)-4,4′,5,5′-tetraphenyl-biimidazole]; the acylphosphineoxide-based compound may be 2,4,6-trimethylbenzoyl diphenylphosphine oxide or bis(2,6-dimethoxybenzoyl)-2,4,4-trimethylpentylphosphine oxide); the triazine-based compound may be 3-{4-[2,4-bis(trichloromethyl)-s-triazine-6-yl]phenylthio}propionic acid, 1,1,1,3,3,3-hexafluoroisopropyl-3-{4-[2,4-bis(trichloromethyl)-s-triazine-6-yl]phenylthio}propionate, ethyl-2-{4-[2,4-bis(trichloromethyl)-s-triazine-6-yl]phenylthio}acetate, methyl-2-epoxyethyl-2-{4-[2,4-bis(trichloromethyl)-s-triazine-6-yl]phenylthio}acetate, methyl-cyclohexyl-2-{4-[2,4-bis(trichloromethyl)-s-triazine-6-yl]phenylthio}acetate, methyl-benzyl-2-{4-[2,4-bis(trichloromethyl)-s-triazine-6-yl]phenylthio}acetate, 3-{chloro-4-[2,4-bis(trichloromethyl)-s-triazine-6-yl]phenylthio}propionic acid, 3-{4-[2,4-bis(trichloromethyl)-s-triazine-6-yl]phenylthio}propionamide, 2,4-bis(trichloromethyl)-6-p-methoxystyryl-s-triazine, 2,4-bis(trichloromethyl)-6-(1-p-dimethylaminophenyl)-1,3,-butadienyl-s-triazine or 2-trichloromethyl-4-amino-6-p-methoxystyryl-s-triazine.

According to embodiments of the disclosure, the acetophenone-based compound may include photo-initiators manufactured by Ciba Geigy under trade numbers such as Irgacure 2959, Irgacure 184, Irgacure 500, Irgacure 651, Irgacure 369, Irgacure 379, Irgacure 907, or Darocur 1173.

According to embodiments of the disclosure, the acylphosphine oxide-based compound may include photo-initiators manufactured by Ciba Geigy under trade numbers such as Irgacure 819 or Irgacure 1800, and by BASF under trade numbers such as Lucirin TPO or Lucirin TPO-L.

According to embodiments of the disclosure, the photo-initiator of the disclosure may include photo-initiators manufactured by LAMBSON with trade numbers such as Esacure 1001M, Esacure KIP150, Speedcure BEM, Speedcure EHA, Speedcure BMS, Speedcure MBP, Speedcure PBZ, Speedcure ITX, Speedcure DETX, Speedcure EBD, Speedcure MBB, or Speedcure BP and by Ciba Geigy with trade numbers such as Irgacure 2100, Irgacure 250 or Irgacure 784.

According to embodiments of the disclosure, the molecular weight of the cross-linking reaction product (i.e., the first adhesive layer) obtained from the first adhesive composition is not limited and can be optionally modified by a person skilled in the field based on practical requirements. According to embodiments of the disclosure, the weight average molecular weight (Mw) of the product obtained from the first adhesive composition can range from about 50,000 g/mol to 2,000,000 g/mol, such as about 80,000 g/mol, 100,000 g/mol, 200,000 g/mol, 300,000 g/mol, 400,000 g/mol, 500,000 g/mol, 800,000 g/mol, 1,000,000 g/mol, or 1,500,000 g/mol.

According to embodiments of the disclosure, the molecular weight of the cross-linking reaction product (i.e., the second adhesive layer) obtained from the second adhesive composition is not limited and can be optionally modified by a person skilled in the field based on practical requirements. According to embodiments of the disclosure, the weight average molecular weight (Mw) of the product obtained from the second adhesive composition can range from about 50,000 g/mol to 2,000,000 g/mol, such as about 80,000 g/mol, 100,000 g/mol, 200,000 g/mol, 300,000 g/mol, 400,000 g/mol, 500,000 g/mol, 800,000 g/mol, 1,000,000 g/mol, or 1,500,000 g/mol. The weight average molecular weight (Mw) of the product obtained from the adhesive composition of the disclosure can be determined by gel permeation chromatography (GPC) based on a polystyrene calibration curve.

According to embodiments of the disclosure, the method for preparing the adhesive layer (such as the first adhesive layer or second adhesive layer) may include the following steps. First, an adhesive composition (such as the first adhesive composition or second adhesive composition) is provided. Next, the adhesive composition is coated on a substrate via a coating process to form a coating layer. Next, the coating layer is subjected to a heating process to obtain the adhesive layer. The temperature of the heating process may be 60° C. to 120° C., and the process time of the heating process may be from 1 minute to 60 minutes.

According to embodiments of the disclosure, the method for preparing the double-sided adhesive may include the following steps. First, a first adhesive composition is coated on a first release liner via a coating process to form a first coating layer. Next, the coating layer is subjected to a heating process to obtain the first adhesive layer disposed on the first release liner. Then, a second adhesive composition is coated on a second release liner via a coating process to form a second coating layer. Next, the coating layer is subjected to a heating process to obtain the second adhesive layer disposed on the second release liner. Finally, the first adhesive layer is disposed on the second adhesive layer and then the result is subjected to a compression process to form a lamination (with a structure of: first release liner/first adhesive layer/second adhesive layer/second release liner).

The thickness of the double-sided adhesive of the disclosure is not limited and can be selected by a person skilled in the field based on practical needs. According to embodiments of the disclosure, the average thickness of the double-sided adhesive may be about 10 m to 500 m, such as 50 m, 100 m, 150 m, 200 m, 300 m, or 400 μm. In addition, according to embodiments of the disclosure, the ratio of the average thickness between the first adhesive layer and the second adhesive layer may be about 5:1 to 1:5, such as 4:1, 3:1, 2:1, 1:1, 1:2, 1:3, or 1:4.

According to embodiments of the disclosure, the disclosure also provides a multilayer structure 100, As shown in FIG. 2. The multilayer structure 100 includes the double-sided adhesive 10 of the disclosure, a first substrate 20, and a second substrate 30, wherein the double-sided adhesive 10 is disposed between the first substrate 20 and the second substrate 30. The double-sided adhesive 10 has a first adhesive layer 12 and a second adhesive layer 14. The first substrate 20 is directly disposed on a first surface 11 of the first adhesive layer 12, and the first substrate 20 directly contacts the first adhesive layer 12. The double-sided adhesive 10 is directly disposed on the second substrate 30, and the second substrate 30 directly contacts a second surface 13 of the second adhesive layer 14.

According to embodiments of the disclosure, the double-sided adhesive 10 is used to fix the first substrate 20 onto the second substrate 30, thereby forming the multilayer structure 100. In addition, when the multilayer structure 100 undergoes a low-temperature treatment, it allows the first substrate 20 to be peeled off from the second substrate 30 without leaving adhesive residue on the second substrate 30. Specifically, after undergoing low-temperature treatment, the adhesion of both the first adhesive layer 12 and the second adhesive layer 14 of the double-sided adhesive 10 decrease. There is a significant difference in adhesion between the first surface 11 of the first adhesive layer 12 and the second surface 13 of the second adhesive layer 14. Therefore, after peeling, the first substrate 20 can be easily removed from the second substrate 30, and the double-sided adhesive 10 remains only on the first substrate 20 without leaving residue on the second substrate 30. As a result, the reusability of the display panel components is enhanced and the efficiency of the reworking process is improved.

According to embodiments of the disclosure, due to the superior gap-filling capability of the first adhesive layer 12, the double-sided adhesive 10 of the disclosure can be used to bond and fill gaps on surfaces with steps on the first substrate 20.

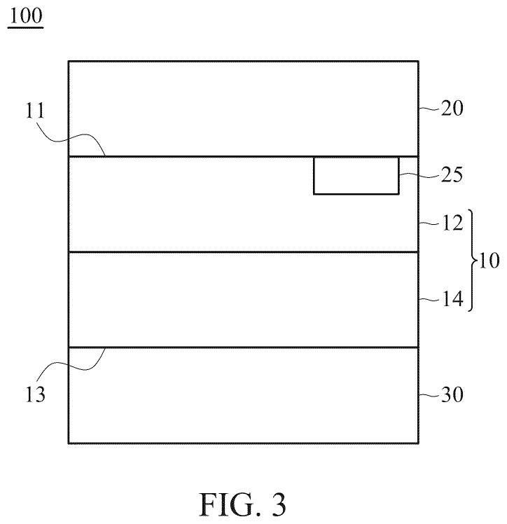

As shown in FIG. 3, the multilayer structure 100 includes the double-sided adhesive 10 of the disclosure, first substrate 20, and second substrate 30. The first substrate 20 may have any desired film layer 25 formed on it, thus creating a step between the film layer 25 and the first substrate 20. Due to the superior gap-filling capability of the first adhesive layer 12 of the double-sided adhesive 10 of the disclosure, when the first adhesive layer 12 of the double-sided adhesive 10 is disposed on the first substrate 20 and when the result is subjected to a compression process (such as rolling or pressing), the first adhesive layer 12 can completely fill the gap between the film layer 25 and the first substrate 20, avoiding the formation of voids.

According to embodiments of the disclosure, the ratio of the step height to the thickness of the first adhesive layer 12 may be 1:1,000 to 1:1, such as 1:1,000, 1:500, 1:300, 1:200, 1:100, 1:50, 1:40, 1:30, 1:20, 1:15, 1:10, 1:8, 1:5, 1:3, 1:2, or 2:3.

In addition, after subjecting the multilayer structure 100 to low-temperature treatment, the adhesion (P1) between the first adhesive layer 12 and the first substrate 20 is greater than the adhesion (P2) between the second adhesive layer 14 and the second substrate 30. The adhesion difference (P1-P2) meets the following equation: (P1-P2)≥200 gf/25 mm (such as 300 gf/25 mm, 400 gf/25 mm, 500 gf/25 mm, 600 gf/25 mm, 700 gf/25 mm, 800 gf/25 mm, 900 gf/25 mm, 1,000 gf/25 mm, or 1,500 gf/25 mm). The peel adherence is measured using a method detailed in ASTM D3330. A tensile testing machine (QC-506B1, Gotech Instruments Co., Ltd.) is used and the polyethylene terephthalate (PET) substrate is peeled at an angle of 180 degrees with a peeling speed of 300 mm/min.

According to embodiments of the disclosure, the first substrate 20 and second substrate 30 may be two substrates that need to be bonded together. According to embodiments of the disclosure, the substrate is not limited and can be optionally modified by a person skilled in the field, which may include metal sheets, silicon substrates, glass, or polymer films, and any desired layer can be formed on these substrates initially. For example, the first substrate 20 and the second substrate 30 may independently be glass, transparent substrate, release liner, optical protective film, brightness enhancement film, phase difference film, polarizer plate, touch panel, anti-reflective film, light guide plate, or diffusion film.

According to some embodiments of the disclosure, the multilayer structure 100 may be a display panel, where the first substrate 20 may be a touch panel, and the second substrate 30 may be a polarizer plate. The touch panel may include transparent glass or a transparent substrate, and transparent conductive electrodes can be formed on at least one surface of the transparent glass or transparent substrate.

According to embodiments of the disclosure, the method for preparing the multilayer structure of the disclosure may include the following steps. First, a lamination having the double-sided adhesive of the disclosure (with a structure of: first release liner/first adhesive layer/second adhesive layer/second release liner) is provided. Next, the first release liner is removed to expose the first surface of the first adhesive layer, and the first substrate is disposed on the first surface of the first adhesive layer. Next, a first compression process is subjected to the result. Next, the second release liner is removed to expose the second surface of the second adhesive layer, and the second adhesive layer is disposed on the second substrate. Next, a second compression process is subjected to the result, obtaining the multilayer structure of the disclosure (with a structure of: first substrate/first adhesive layer/second adhesive layer/second substrate). In addition, after the first compression process, the first adhesive layer can be cured by irradiating with a light source (such as ultraviolet light) to initiate a curing reaction.

Below, exemplary embodiments will be described in detail with reference to the accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### Preparation of Acrylic Resin

### Preparation Example 1

388.19 g of ethyl acetate was added into a reaction bottle under nitrogen atmosphere. Next, 18.96 g of hydroxyethyl acrylate (Tg=258K), 28.23 g of acryloyl morpholine (Tg=418K), 17.06 g of acrylamide (Tg=438K), 63.20 g of n-butyl methacrylate (Tg=293K), 387.13 g of n-butyl acrylate (Tg=219K), and 1.29 g of azobisisobutyronitrile were added into the reaction bottle. After reacting at 85° C. for 16 hours, a solution including Acrylic resin (1) (with a solid content of about 57.1%) was obtained.

### Preparation Example 2

384.19 g of ethyl acetate was added into a reaction bottle under nitrogen atmosphere. Next, 18.96 g of hydroxyethyl acrylate (Tg=258K), 45.17 g of acryloyl morpholine (Tg=418K), 27.29 g of acrylamide (Tg=438K), 86.18 g of n-butyl methacrylate (Tg=293K), 384.19 g of n-butyl acrylate (Tg=219K), and 1.27 g of azobisisobutyronitrile were added into the reaction bottle. After reacting at 85° C. for 16 hours, a solution including Acrylic resin (2) (with a solid content of about 57.1%) was obtained

The amount of the first monomer, second monomer, and third monomer used to prepare Acrylic resin (1) and Acrylic resin (2), along with the estimated glass transition temperatures of Acrylic resin (1) and Acrylic resin (2), are shown in Table 1. The estimated glass transition temperatures are calculated using the Fox equation.

TABLE 1

| | | | | estimated glass |
|---|---|---|---|---|
| | first | second | third | transition |
| | monomer | monomer | monomer | temperature |
| | (wt %) | (wt %) | (wt %) | (° C.) |
| acrylic resin | 3.68 | 75.23 | 21.08 | −35 |
| (1) | | | | |
| acrylic resin | 3.72 | 65.13 | 31.15 | −25 |
| (2) | | | | |

### Preparation of Adhesive Composition and Adhesive Layer

### Preparation Example 3

0.1 g of dibutyltin dilaurate (DBTDL) and 9.9 g of ethyl acetate were mixed to obtain a DBTDL solution. Next, 1 g of hexamethylene diisocyanate (HMDI) and 9 g of ethyl acetate were mixed to obtain an HMDI solution. Next, 175.25 g of the solution including Acrylic resin (1) and 103.0 g of ethyl acetate were added into a reaction bottle. After thoroughly stirring, 1.33 g of the HMDI solution and 0.25 g of the DBTDL solution were added into the reaction bottle. After stirring for 30 minutes, Adhesive composition (1) (with a solid content of about 35.8%) was obtained.

### Preparation Example 4

0.1 g of dibutyltin dilaurate (DBTDL) and 9.9 g of ethyl acetate were mixed to obtain a DBTDL solution. Next, 1 g of hexamethylene diisocyanate (HMDI) and 9 g of ethyl acetate were mixed to obtain an HMDI solution. Next, 175.25 g of the solution including Acrylic resin (2) and 103.0 g of ethyl acetate were added into a reaction bottle. After thoroughly stirring, 1.58 g of the HMDI solution and 0.25 g of the DBTDL solution were added into the reaction bottle. After stirring for 30 minutes, Adhesive composition (2) (with a solid content of about 35.8%) was obtained.

The Adhesive composition (2) was coated onto a release liner (polyethylene terephthalate (PET), having a thickness of 38 m, available from Nan Ya Plastics Industry with a trade number of H338A) with a doctor blade (having a gap of 420 μm and a width of 150 mm) and a flow coating machine (available from ZEHNTNER with a trade number of ZAA2300). Next, the coated release liner was placed in an oven and baked at 100° C. for 5 minutes, followed by curing at 70° C. for 18 hours. After cooling to room temperature and standing, Adhesive layer (1) with a thickness of about 90 m was obtained which was disposed on the heavy-release-strength PET release liner.

### Preparation Example 5

100 g of Adhesive composition (1) and 5 g of isobornyl acrylate were mixed, obtaining Adhesive composition (3).

Adhesive composition (3) was coated onto a release liner (polyethylene terephthalate (PET), having a thickness of 38 m, available from Nan Ya Plastics Industry with a trade number of LA38A) with a doctor blade (having a gap of 420 m and a width of 150 mm) and a flow coating machine (available from ZEHNTNER with the trade number of ZAA2300). Next, the coated release liner was placed in an oven and baked at 100° C. for 5 minutes, followed by curing at 70° C. for 18 hours. After cooling to room temperature and standing, Adhesive layer (2) with a thickness of about 90 m was obtained which was disposed on the light-release-strength PET release liner.

### Preparation Example 6

100 g of Adhesive composition (1) and 10 g of isobornyl acrylate were mixed, obtaining Adhesive composition (4).

Adhesive composition (4) was coated onto a release liner (polyethylene terephthalate (PET, having a thickness of 38 m, available from Nan Ya Plastics Industry with a trade number of LA38A) with a doctor blade (having a gap of 420 m and a width of 150 mm) and a flow coating machine (available from ZEHNTNER with the trade number of ZAA2300). Next, the coated release liner was placed in an oven and baked at 100° C. for 5 minutes, followed by curing at 70° C. for 18 hours. After cooling to room temperature and standing, Adhesive layer (3) with a thickness of about 90 m was obtained which was disposed on the light-release-strength PET release liner.

### Preparation Example 7

100 g of Adhesive composition (1), 5 g of isobornyl acrylate, and 0.5 g of photo-initiator (bis(2,4,6-trimethylbenzoyl)-phenylphosphineoxide, available from Double Bond Chemical with the trade number of 819) were mixed, obtaining Adhesive composition (5).

Adhesive composition (5) was coated onto a release liner (polyethylene terephthalate (PET), having a thickness of 38 m, available from Nan Ya Plastics Industry with a trade number of LA38A) with a doctor blade (having a gap of 420 m and a width of 150 mm) and a flow coating machine (available from ZEHNTNER with the trade number of ZAA2300). Next, the coated release liner was placed in an oven and baked at 100° C. for 5 minutes, followed by curing at 70° C. for 18 hours. After cooling to room temperature and standing, Adhesive layer (4) with a thickness of about 90 m was obtained which was disposed on the light-release-strength PET release liner.

### Preparation Example 8

100 g of Adhesive composition (1), 5 g of isobornyl acrylate, and 1 g of photo-initiator (bis(2,4,6-trimethylbenzoyl)-phenylphosphineoxide, available from Double Bond Chemical with the trade number of 819) were mixed, obtaining Adhesive composition (6).

Adhesive composition (6) was coated onto a release liner (polyethylene terephthalate (PET), having a thickness of 38 μm, available from Nan Ya Plastics Industry with a trade number of LA38A) with a doctor blade (having a gap of 420 μm and a width of 150 mm) and a flow coating machine (available from ZEHNTNER with the trade number of ZAA2300). Next, the coated release liner was placed in an oven and baked at 100° C. for 5 minutes, followed by curing at 70° C. for 18 hours. After cooling to room temperature and standing, Adhesive layer (5) with a thickness of about 90 m was obtained which was disposed on the light-release-strength PET release liner.

### Comparative Example 1

Adhesive composition (1) was coated onto a release liner (polyethylene terephthalate (PET), having a thickness of 38 m, available from Nan Ya Plastics Industry with a trade number of LA38A) with a doctor blade (having a gap of 420 μm and a width of 150 mm) and a flow coating machine (available from ZEHNTNER with the trade number of ZAA2300). Next, the coated release liner was placed in an oven and baked at 100° C. for 5 minutes, followed by curing at 70° C. for 18 hours. After cooling to room temperature and standing, Adhesive layer (6) with a thickness of about 90 m was obtained which was disposed on the light-release-strength PET release liner.

### Comparative Example 2

100 g of Adhesive composition (1) and 15 g of isobornyl acrylate were mixed, obtaining Adhesive composition (7).

Adhesive composition (7) was coated onto a release liner (polyethylene terephthalate (PET), having a thickness of 38 m, available from Nan Ya Plastics Industry with a trade number of LA38A) with a doctor blade (having a gap of 420 μm and a width of 150 mm) and a flow coating machine (available from ZEHNTNER with the trade number of ZAA2300). Next, the coated release liner was placed in an oven and baked at 100° C. for 5 minutes, followed by curing at 70° C. for 18 hours. After cooling to room temperature and standing, Adhesive layer (7) with a thickness of about 90 m was obtained which was disposed on the light-release-strength PET release liner.

### Comparative Example 3

100 g of Adhesive composition (1) and 20 g of isobornyl acrylate were mixed, obtaining Adhesive composition (8).

Adhesive composition (8) was coated onto a release liner (polyethylene terephthalate (PET), having a thickness of 38 m, available from Nan Ya Plastics Industry with a trade number of LA38A) with a doctor blade (having a gap of 420 μm and a width of 150 mm) and a flow coating machine (available from ZEHNTNER with the trade number of ZAA2300). Next, the coated release liner was placed in an oven and baked at 100° C. for 5 minutes, followed by curing at 70° C. for 18 hours. After cooling to room temperature and standing, Adhesive layer (8) with a thickness of about 90 m was obtained which was disposed on the light-release-strength PET release liner.

### Comparative Example 4

100 g of Adhesive composition (1), 5 g of isobornyl acrylate, and 2 g of photo-initiator (bis(2,4,6-trimethylbenzoyl)-phenylphosphineoxide, available from Double Bond Chemical with the trade number of 819) were mixed, obtaining Adhesive composition (9).

Adhesive composition (9) was coated onto a release liner (polyethylene terephthalate (PET), having a thickness of 38 m, available from Nan Ya Plastics Industry with a trade number of LA38A) with a doctor blade (having a gap of 420 μm and a width of 150 mm) and a flow coating machine (available from ZEHNTNER with the trade number of ZAA2300). Next, the coated release liner was placed in an oven and baked at 100° C. for 5 minutes, followed by curing at 70° C. for 18 hours. After cooling to room temperature and standing, Adhesive layer (9) with a thickness of about 90 m was obtained which was disposed on the light-release-strength PET release liner.

### Preparation Example 9

100 g of Adhesive composition (1), 5 g of tetrahydrofurfuryl acrylate, and 0.5 g of photo-initiator (bis(2,4,6-trimethylbenzoyl)-phenylphosphineoxide, available from Double Bond Chemical with the trade number of 819) were mixed, obtaining Adhesive composition (10).

Adhesive composition (10) was coated onto a release liner (polyethylene terephthalate (PET), having a thickness of 38 m, available from Nan Ya Plastics Industry with a trade number of LA38A) with a doctor blade (having a gap of 420 μm and a width of 150 mm) and a flow coating machine (available from ZEHNTNER with the trade number of ZAA2300). Next, the coated release liner was placed in an oven and baked at 100° C. for 5 minutes, followed by curing at 70° C. for 18 hours. After cooling to room temperature and standing, Adhesive layer (10) with a thickness of about 90 m was obtained which was disposed on the light-release-strength PET release liner.

### Preparation Example 10

100 g of Adhesive composition (1), 5 g of 2-N-morpholinoethyl methacrylate, and 0.5 g of photo-initiator (bis(2,4,6-trimethylbenzoyl)-phenylphosphineoxide, available from Double Bond Chemical with the trade number of 819) were mixed, obtaining Adhesive composition (11).

Adhesive composition (11) was coated onto a release liner (polyethylene terephthalate (PET), having a thickness of 38 m, available from Nan Ya Plastics Industry with a trade number of LA38A) with a doctor blade (having a gap of 420 μm and a width of 150 mm) and a flow coating machine (available from ZEHNTNER with the trade number of ZAA2300). Next, the coated release liner was placed in an oven and baked at 100° C. for 5 minutes, followed by curing at 70° C. for 18 hours. After cooling to room temperature and standing, Adhesive layer (11) with a thickness of about 90 m was obtained which was disposed on the light-release-strength PET release liner.

### Preparation Example 11

100 g of Adhesive composition (1), 5 g of cyclic trimethylolpropane formal acrylate, and 0.5 g of photo-initiator (bis(2,4,6-trimethylbenzoyl)-phenylphosphineoxide, available from Double Bond Chemical with the trade number of 819) were mixed, obtaining Adhesive composition (12).

Adhesive composition (12) was coated onto a release liner (polyethylene terephthalate (PET), having a thickness of 38 m, available from Nan Ya Plastics Industry with a trade number of LA38A) with a doctor blade (having a gap of 420 μm and a width of 150 mm) and a flow coating machine (available from ZEHNTNER with the trade number of ZAA2300). Next, the coated release liner was placed in an oven and baked at 100° C. for 5 minutes, followed by curing at 70° C. for 18 hours. After cooling to room temperature and standing, Adhesive layer (12) with a thickness of about 90 m was obtained which was disposed on the light-release-strength PET release liner.

### Double-Sided Adhesive

### Example 1

Adhesive layer (2) disposed on the light-release-strength PET release liner and Adhesive layer (1) disposed on the heavy-release-strength PET release liner were combined to force Adhesive layer (1) contact Adhesive layer (2), obtaining a lamination including Double-sided adhesive (1) (with a laminated structure of: light-release-strength PET release liner/Adhesive layer (2)/Adhesive layer (1)/heavy-release-strength PET release liner).

### Example 2

Example 2 was performed in the same manner as in Example 1, except that Adhesive layer (2) was replaced with Adhesive layer (3), obtaining a lamination including Double-sided adhesive (2) (with a laminated structure of light-release-strength PET release liner/Adhesive layer (3)/Adhesive layer (1)/heavy-release-strength PET release liner).

### Example 3

Example 3 was performed in the same manner as in Example 1, except that Adhesive layer (2) was replaced with Adhesive layer (4), obtaining a lamination including Double-sided adhesive (3) (with a laminated structure of light-release-strength PET release liner/Adhesive layer (4)/Adhesive layer (1)/heavy-release-strength PET release liner).

### Example 4

Example 4 was performed in the same manner as in Example 1, except that Adhesive layer (2) was replaced with Adhesive layer (5), obtaining a lamination including Double-sided adhesive (4) (with a laminated structure of light-release-strength PET release liner/Adhesive layer (5)/Adhesive layer (1)/heavy-release-strength PET release liner).

### Comparative Example 5

Comparative Example 5 was performed in the same manner as in Example 1, except that Adhesive layer (2) was replaced with Adhesive layer (6), obtaining a lamination including Double-sided adhesive (5) (with a laminated structure of light-release-strength PET release liner/Adhesive layer (6)/Adhesive layer (1)/heavy-release-strength PET release liner).

### Comparative Example 6

Comparative Example 6 was performed in the same manner as in Example 1, except that Adhesive layer (2) was replaced with Adhesive layer (7), obtaining a lamination including Double-sided adhesive (6) (with a laminated structure of: light-release-strength PET release liner/Adhesive layer (7)/Adhesive layer (1)/heavy-release-strength PET release liner).

### Comparative Example 7

Comparative Example 7 was performed in the same manner as in Example 1, except that Adhesive layer (2) was replaced with Adhesive layer (8), obtaining a lamination including Double-sided adhesive (7) (with a laminated structure of light-release-strength PET release liner/Adhesive layer (8)/Adhesive layer (1)/heavy-release-strength PET release liner).

### Comparative Example 8

Comparative Example 8 was performed in the same manner as in Example 1, except that Adhesive layer (2) was replaced with Adhesive layer (9), obtaining a lamination including Double-sided adhesive (8) (with a laminated structure of: light-release-strength PET release liner/Adhesive layer (9)/Adhesive layer (1)/heavy-release-strength PET release liner).

Evaluation of adhesive layer A glass panel (with a size of 45 mm×75 mm and a thickness of 1.8 mm) was provided and then a polyethylene terephthalate (PET) pattern (with a size of 20 mm×65 mm and a thickness of about 25 μm) was formed on the top surface of the glass panel. The laminations including the double-sided adhesive as disclosed in Examples 1-4 and Comparative Examples 5-8 were cut to obtain rectangular prepregs (with a size of 45 mm×75 mm). Next, the light-release-strength PET release liner was removed from the rectangular prepreg to expose the adhesive layer. Next, the adhesive layer of the rectangular prepreg was adhered onto the glass panel having the PET pattern, and then the rectangular prepreg was rolled back and forth with a 2 kg roller to press on the heavy-release-strength PET release liner of the prepreg. Next, the interface between the PET pattern and the glass panel was observed by an optical microscope. If the adhesive layer can completely fill the gap between the PET pattern and the glass panel, the evaluation was marked with O. Otherwise, it was marked with X. The results are shown in Table 2.

Next, the rectangular prepreg was irradiated with ultraviolet (UV) light (having a wavelength of about 365 nm) to cure it, and the result was observed by an optical microscope to determine whether there were any void defects in the cured adhesive layer (i.e., the adhesive layer in contact with the glass panel). The results are shown in Table 2. In additional, the b* value of the adhesive layer in contact with the glass panel was measured. The b* value was measured using a method detailed in JIS Z 8730:2009.

TABLE 2

| | gap-filling capability | void defect | b* value |
|---|---|---|---|
| Example 1 | ◯ | No | 0.15 |
| Example 2 | ◯ | No | 0.15 |
| Example 3 | ◯ | No | 0.16 |
| Example 4 | ◯ | No | 0.18 |
| Comparative | X | Yes | 0.15 |
| Example 5 | | | |
| Comparative | X | No | 0.16 |
| Example 6 | | | |
| Comparative | X | No | 0.16 |
| Example 7 | | | |
| Comparative | ◯ | No | 0.31 |
| Example 8 | | | |

As shown in Table 2, due to the specific components (such as the combination of the first acrylic resin, first crosslinking agent, and the compound having a structure represented by Formula (I)) and the specific amount among the components (such as the weight ratio of the compound having a structure represented by Formula (I) to the first acrylic resin being about 10:90 to 25:75), the adhesive layer prepared from the first adhesive composition of the disclosure exhibits gap-filling capability which allows the adhesive layer to completely fill the gap between the PET pattern and the glass panel. In contrast, when the adhesive composition does not include the compound having a structure represented by Formula (I), the obtained adhesive layer (as disclosed in Comparative Example 5) lacks gap-filling capability and exhibits void defects.

Furthermore, when the weight ratio of the compound having a structure represented by Formula (I) to the first acrylic resin is too high, the obtained adhesive layers (as disclosed in Comparative Examples 6 and 7) also lack gap-filling capability.

In addition, when the amount of the photo-initiator in the adhesive composition is too high, the obtained adhesive layer (as in Comparative Example 8) was apt to yellow easily after exposure to UV light.

### Example 5

Example 5 was performed in the same manner as in Example 1, except that Adhesive layer (2) was replaced with Adhesive layer (10), obtaining a lamination including Double-sided adhesive (9) (with a laminated structure of: light-release-strength PET release liner/Adhesive layer (10)/Adhesive layer (1)/heavy-release-strength PET release liner).

### Example 6

Example 6 was performed in the same manner as in Example 1, except that Adhesive layer (2) was replaced with Adhesive layer (11), obtaining a lamination including Double-sided adhesive (10) (with a laminated structure of: light-release-strength PET release liner/Adhesive layer (11)/Adhesive layer (1)/heavy-release-strength PET release liner).

### Example 7

Example 7 was performed in the same manner as in Example 1, except that Adhesive layer (2) was replaced with Adhesive layer (12), obtaining a lamination including Double-sided adhesive (11) (with a laminated structure of: light-release-strength PET release liner/Adhesive layer (12)/Adhesive layer (1)/heavy-release-strength PET release liner).

Evaluation of adhesive layer A glass panel (with a size of 45 mm×75 mm and a thickness of 1.8 mm) was provided and then a polyethylene terephthalate (PET) pattern (with a size of 20 mm×65 mm and a thickness of about 25 μm) was formed on the top surface of the glass panel. The laminations including the double-sided adhesives as disclosed in Examples 5-8 were cut to obtain rectangular prepregs (with a size of 45 mm×75 mm). Next, the light-release-strength PET release liner was removed from the rectangular prepregs to expose the adhesive layers. Next, the adhesive layer of the rectangular prepreg was adhered onto the glass panel having the PET pattern, and then the rectangular prepreg was rolled back and forth with a 2 kg roller to press the heavy-release-strength PET release liner of the prepreg. Next, the interface between the PET pattern and the glass panel was observed by an optical microscope. If the adhesive layer can completely fill the gap between the PET graphic and the glass panel, the evaluation was marked with O. Otherwise, it was marked with X. The results are shown in Table 3.

Next, the rectangular prepreg was irradiated with ultraviolet (UV) light (having a wavelength of about 365 nm) to cure it, and the result was observed by an optical microscope to determine whether there were any void defects in the cured adhesive layer (i.e., the adhesive layer in contact with the glass panel). The results are shown in Table 3. In additional, the b* value of the adhesive layer in contact with the glass panel was measured. The b* value was measured using a method detailed in JIS Z 8730:2009.

TABLE 3

| | gap-filling capability | void defect | b* value |
|---|---|---|---|
| Example 5 | ◯ | No | 0.16 |
| Example 6 | ◯ | No | 0.17 |
| Example 7 | ◯ | No | 0.15 |

### Preparation of Multilayer Structure and Rework Test

### Example 8

A polarizer plate (with a structure of protective film/polarizer film/pressure-sensitive adhesive/release liner)(with a size of 45 mm×75 mm, the polarizer film available from Lite Optoelectronics with the trade number of MIC25518) was provided, and then the protective film of polarizer plate was removed. The lamination as disclosed in Example 1, which includes Double-sided adhesive (1), was provided. After cutting, a rectangular prepreg (size: 45 mm×75 mm) of the lamination as disclosed in Example 1 was obtained. Next, the light-release-strength release liner was removed from the rectangular prepreg to expose Adhesive layer (2). Next, a glass plate (with a thickness of 1.8 mm) was provided, and then the glass plate was adhered to Adhesive layer (2) of the rectangular prepreg. Next, the rectangular prepreg was rolled back and forth with a 2 kg roller to press on the heavy-release-strength PET release liner of the prepreg. Next, the heavy-release-strength PET release liner was removed from the rectangular prepreg to expose Adhesive layer (1). Then, Adhesive layer (1) of the rectangular prepreg was adhered to the polarizer film of the polarizer plate. Next, the polarizer plate was rolled back and forth with a 2 kg roller to press on the release liner of the polarizer plate, obtaining Multilayer structure (1) (with a structure of glass plate/Adhesive layer (2)/Adhesive layer (1)/polarizer film/pressure-sensitive adhesive/release liner).

After subjecting Multilayer structure (1) to low-temperature treatment at −30° C. for 30 minutes, the difference in adhesion between the glass plate/Adhesive layer (1) and Adhesive layer (2)/polarizer film was evaluated, and the results are shown in Table 4. The peeling adhesion was measured using a method detailed in ASTM D3330.

Additionally, after subjecting multilayer structure (1) to low-temperature treatment at −30° C. for 30 minutes, the glass plate and polarizer film were peeled from Multilayer structure (1). The residue of Double-sided adhesive (1) (adhesive layer (1)/Adhesive layer (2)) on the glass plate and polarizer film were observed, and the results are shown in Table 4

TABLE 4

| | Multilayer |
|---|---|
| | structure (1) |
| low-temperature treatment temperature (° C.) | −30 |
| double-sided adhesive residue on the glass plate | Yes |
| double-sided adhesive residue on the polarizer film | No |
| adhesion (glass plate/first adhesive layer) − adhesion | ~750 |
| (second adhesive layer/polarizer film) (gf/25 mm) | |

As shown in Table 4, the multilayer structure prepared from the double-sided adhesive of the disclosure can exhibit a significant difference in adhesion between the first adhesive layer and the second adhesive layer (with substrates, respectively) after low-temperature treatment by adjusting the amounts of the third monomer (hard monomer) used to prepare the acrylic resin for the first adhesive layer (W1) and the acrylic resin for the second adhesive layer (W2) (i.e., W2-W1≥7 wt %). As a result, it allows for easy separation of the glass plate and the polarizer film without leaving residue of the double-sided adhesive on the polarizer film.

Furthermore, the first adhesive layer exhibits improved gap-filling capability by employing specific components of the first adhesive layer. As a result, even if there are steps on the bonding surface of the substrate, the first adhesive layer of the double-sided adhesive can adequately fill the steps, thereby avoiding the formation of void defects between the bonding surfaces of the substrate during the bonding process. Additionally, by controlling the difference in the hard monomer amounts in the first adhesive layer and the second adhesive layer, the adhesion between the first adhesive layer and the second adhesive layer of the double-sided adhesive, with substrates respectively, can exhibit significant differences after low-temperature treatment.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A double-sided adhesive, comprising:
a first adhesive layer, which is a product of a first adhesive composition via a cross-linking reaction, wherein the first adhesive composition comprises a first acrylic resin, a first crosslinking agent, and a compound having a structure represented by Formula (I) 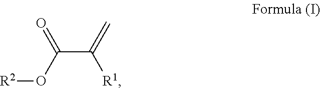
wherein R¹ is hydrogen or methyl group; and R² is 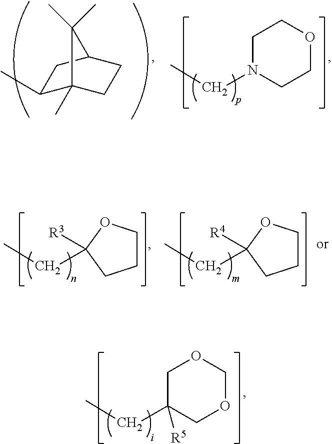
wherein p is 1,
2 or 3; n is 0, 1, 2 or 3; m is 0, 1, 2 or 3; i is 0, 1, 2 or 3; and R³, R⁴ and
R⁵ are independently hydrogen or C₁-C₄ alkyl group; and
a second adhesive layer, which is a product of a second adhesive composition via a cross-linking reaction, wherein the second adhesive composition comprises a second acrylic resin and a second crosslinking agent, wherein the first adhesive layer has a glass transition temperature of Tg¹, and the second adhesive layer has a glass transition temperature of Tg², wherein Tg² is less than or equal to −30° C., and Tg²-Tg¹≥10° C.

2. The double-sided adhesive as claimed in claim 1, wherein a weight ratio of the compound having a structure represented by Formula (I) to the first acrylic resin is 10:90 to 25:75.

3. The double-sided adhesive as claimed in claim 1, wherein the first acrylic resin is a product of a first resin composition via copolymerization, wherein the first resin composition comprises an (A1) monomer, wherein the (A1) monomer comprises a first monomer, a second monomer, and a third monomer, wherein the first monomer is an acrylate monomer having a hydroxyl group; the second monomer is an acrylate monomer in which a homopolymer thereof has a glass transition temperature less than or equal to −20° C.; and the third monomer is a monomer having a terminal vinyl group, in which a homopolymer thereof has a glass transition temperature greater than or equal to 0° C.

4. The double-sided adhesive as claimed in claim 3, wherein the second acrylic resin is a product of a second resin composition via copolymerization, wherein the second resin composition comprises a (B1) monomer, wherein the (B1) monomer comprises the first monomer, the second monomer, and the third monomer.

5. The double-sided adhesive as claimed in claim 4, wherein the third monomer has a weight percentage of W1 in the (A1) monomer, based on a total weight of the (A1) monomer; the third monomer has a weight percentage of W2 in the (B1) monomer, based on a total weight of the (B1) monomer; and 45 wt %≥W2-W1≥7 wt %.

6. The double-sided adhesive as claimed in claim 3, wherein in the (A1) monomer, the first monomer has a weight percentage of 1 wt % to 10 wt %, the second monomer has a weight percentage of 50 wt % to 95 wt %, and the third monomer has a weight percentage of 4 wt % to 42 wt %, based on the total weight of the (A1) monomer.

7. The double-sided adhesive as claimed in claim 4, wherein in the (B1) monomer, the first monomer has a weight percentage of 1 wt % to 10 wt %, the second monomer has a weight percentage of 50 wt % to 95 wt %, and the third monomer has a weight percentage of 11 wt % to 49 wt %, based on the total weight of the (B1) monomer.

8. The double-sided adhesive as claimed in claim 3, wherein the first monomer is 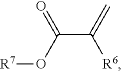
wherein R6 is hydrogen or methyl group, and R7 is hydrogen or C1-C10 alkylol group.

9. The double-sided adhesive as claimed in claim 3, wherein the second monomer is n-butyl acrylate, sec-butyl acrylate, ethyl acrylate, 2-ethylhexyl acrylate, ethoxyethyl acrylate, isononyl acrylate, lauryl methacrylate, or a combination thereof.

10. The double-sided adhesive as claimed in claim 3, wherein the third monomer is tert-butyl acrylate, n-butyl methacrylate, sec-butyl methacrylate, tert-butyl methacrylate, cyclohexyl acrylate, cyclohexyl methacrylate, methyl acrylate, methyl methacrylate, acrylonitrile, acrylamide, acryloyl morpholine, N-vinyl-2-pyrrolidone, or a combination thereof.

11. The double-sided adhesive as claimed in claim 1, wherein the second adhesive composition comprises a compound having a structure represented by Formula (I) or the second adhesive composition does not comprise a compound having a structure represented by Formula (I).

12. The double-sided adhesive as claimed in claim 1, wherein the first crosslinking agent and second crosslinking agent are independently a compound with at least two cross-linkable functional groups, wherein the cross-linkable functional group is isocyanate group, carboxyl group, aziridine group, anhydride group, or melamine group.

13. The double-sided adhesive as claimed in claim 1, wherein a weight ratio of the first crosslinking agent to the first acrylic resin is 1:5,000 to 5:100, and a weight ratio of the second crosslinking agent to the second acrylic resin is 1:5,000 to 5:100.

14. The double-sided adhesive as claimed in claim 3, wherein the first resin composition further comprises an (A2) initiator, and the second resin composition further comprises a (B2) initiator.

15. The double-sided adhesive as claimed in claim 3, wherein components of the (A1) monomer of the first resin composition are the same as components of the (B1) monomer of the second resin composition, or the components of the (A1) monomer of the first resin composition are different from the components of the (B1) monomer of the second resin composition.

16. The double-sided adhesive as claimed in claim 1, wherein the first adhesive composition further comprises a photo-initiator, wherein a weight ratio of the photo-initiator to the first acrylic resin is 0.01:99.99 to 3:97.

17. A multilayer structure, comprising:
a first substrate;
a second substrate; and
the double-sided adhesive as claimed in claim 1, wherein the first adhesive layer has a first surface, the second adhesive layer has a second surface, the first surface contacts the first substrate, and the second surface contacts the second substrate.

18. The multilayer structure as claimed in claim 17, wherein the first substrate and the second substrate are independently glass, transparent substrate, release film, optical protective film, brightening film, phase difference film, polarizer plate, touch panel, anti-reflection film, light guide plate, or diffusion film.
